(19) United States
(12) Patent Application Publication
(10) Pub. No.: US 2010/0213410 A1
(43) Pub. Date: Aug. 26, 2010

(54) AQUEOUS FUNCTIONAL FLUIDS WITH ANTIOXIDANTS

(76) Inventors: Peter Rohrbach, Liestal (CH); Samuel Evans, Marly (CH); Stefan Laeuger, Rheinfelden-Degerfelden (DE)

Correspondence Address: BASF Performance Products LLC;Patent Department, 540 White Plains Road, P.O. Box 2005, Tarrytown, NY, 10591, US

(21) Appl. No.: 12/772,431

(22) Filed: May 3, 2010

Related U.S. Application Data
(63) Continuation of application No. 10/496,234, filed on May 19, 2004.

(30) Foreign Application Priority Data
Nov. 21, 2001 (EP) 01811119.5

(51) Int. Cl. C09K 3/00

(52) U.S. Cl. 252/182.31

(57) ABSTRACT

The present invention relates to an aqueous functional fluid comprising an antioxidant of the hindered phenol type and a water-soluble polyalkylene glycol. The aqueous functional fluids are especially suitable for use as hydraulic or metal working fluids. The present invention also relates to the use of the aqueous functional fluid for improving the performance properties of hydraulic or metal working fluids.

This application is a continuation of copending application Ser. No. 10/496,234, filed on May 19, 2004 which is the National Stage of International Application PCT/EP02/12681, filed Nov. 13, 2002, the contents of which are herein incorporated by reference.

The invention relates to aqueous functional fluids comprising 4-hydroxyphenylpropionic acid esters and water-soluble polyalkylene glycols and to the use of these aqueous functional fluids for improving the performance properties of metalworking fluids or hydraulic fluids.

Additives are added to functional fluids, such as hydraulic or metal working fluids, in order to improve the antioxidative properties of the fluid or to comply with demanding technical and ecological requirements, such as high load-carrying capacity or protection against corrosion and wear. Zinc dialkyl dithiophosphates are commonly used, but due to environmental reasons, various attempts have been made to replace these compounds with metal-free compounds. The use of metal-free hydraulic fluids is mandatory, especially in agricultural machinery or generally in mobile hydraulic units, where leakages present the ecological risk of contamination of soil or water with zinc compounds. Therefore, there is a need for metal-free and ashless additives. Suitable hydraulic fluids should also comply with the specifications of the leading hydraulic machine manufacturers, for example Denison HFO (Denison Hydraulics) or Vickers M-2980-S (Vickers), and need to be compatible with water. In addition, in accordance with the specifications of DIN 51524 and Denison HFO, they should achieve a failure load stage (FLS) of at least 10 in the FZG test.

U.S. Pat. No. 5,531,911 discloses zinc-free hydraulic fluids based on oil that comprise phosphorus- and sulphur-containing additive components. One component is a thiophosphoric acid ester of the triphenylthiophosphate type, e.g. Irgalube® (trade mark of Ciba Specialty Chemicals) TPPT. This component is combined with dithiophosphoric acid esters of the IRGALUBE 63 type and with other optional oil additive components, for example ammonium sulphonates.

A disadvantage of oily formulations is their flammability, especially at higher working temperatures of the machinery employed. Fire resistant hydraulic fluids are mandatory in many applications to minimise the problems associated with leaks of hydraulic fluid from high pressure lines coming in contact with hot equipment, e.g. welding machines, machine tools or die casting machines in the automotive and steel industries.

Further disadvantages of oily formulations relate to the high costs of waste disposal of used oily liquids and the lack of compatibility with water. The contamination of hydraulic oils with water occurs frequently, especially when mobile hydraulic units are used. The presence of phosphorus and sulphur containing additives causes hydrolytic degradation with subsequent formation of corrosive decomposition products. They may attack the metals used in the hydraulic units, e.g. steel and copper alloys, and cause damage to hydraulic pumps. In addition, agglomerations of decomposition products may also block the filters of by-pass filtration units. It is known that the service life of hydraulic units can be significantly extended by means of very fine filtering. Therefore, the filter pore sizes of by-pass filtration units have been reduced from 30μ to 6μ. Consequently, only hydraulic oils that form only extremely small amounts of insoluble hydrolytic decomposition products when contaminated with water can efficiently be used.

Hydraulic fluids having water as a base are disclosed in U.S. Pat. Nos. 4,151,059 and 4,138,346. While hydraulic fluids of any type are primarily used to transmit forces, fluids additionally have to provide lubrication of the mechanical parts of the equipment in order to prevent excessive wear.

Driven by environmental, economic and safety aspects the use of water based fluids, instead of neat oils, is also recommended for quenching and cooling operations in metal working processes. One type of fluids that satisfy these requirements is polyalkylene glycols combined with water in various proportions. Due to the relatively high temperatures involved in the quenching process, the polyalkylene glycols are degraded by oxidation. To overcome this problem, various antioxidants have been proposed.

According to U.S. Pat. No. 4,686,058 high viscosity water hydraulic fluids are prepared by blending water, organic thickeners, such as polyoxyalkylene polyols, and conventional hydraulic fluid additives, such as hindered phenols.

The problem underlying the present invention is the preparation of aqueous functional fluids useful as hydraulic or metal working fluids that have improved compatibility with water and a significantly lower tendency to form undesirable oxidation and hydrolysis products.

It has surprisingly been found that the addition of a suitable antioxidant of the hindered phenol type to an aqueous fluid comprising water soluble polyalkylene glycol or mixtures thereof produces compositions that meet the above-mentioned specifications and have a significantly lower tendency to form corrosive hydrolysis products.

Therefore, the present invention relates to a functional fluid comprising
a) A 4-hydroxyphenylpropionic acid ester:

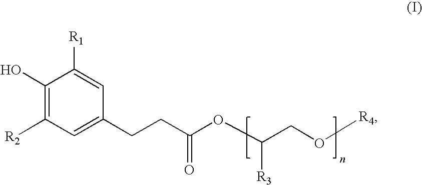

wherein
one of R₁ and R₂ represents hydrogen or C₁-C₉alkyl; and the other one represents C₃-C₉alkyl;
R₃ represents hydrogen or methyl;
R₄ represents hydrogen, C₁-C₃₀alkyl, (C₁-C₄alkyl)₁₋₃phenyl, phenyl or the group:

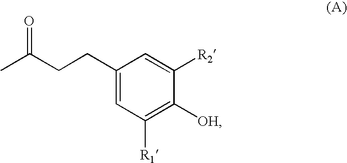

wherein
R₁′ and R₂′ have the same meanings as R₁ and R₂ defined above; and
n represents a numeral from 1 to 60;
b) Water soluble polyalkylene glycol or mixtures thereof; and
c) Water.

The aqueous functional fluids are especially suitable for use as hydraulic or metal working fluids. Therefore, the present invention also relates to the use of the aqueous functional fluid defined above for improving the performance properties of hydraulic or metal working fluids.

These fluids are substantially ashless and metal free and meet the above-mentioned specifications.

The terms and definitions used in the context of the description of the present invention preferably have the following meanings:

### Component a)

In a compound (I) R₁ and R₂ defined as C₁-C₉alkyl comprise unbranched and branched (where possible) groups, for example methyl, ethyl, isopropyl, n-butyl, isobutyl, tert-butyl, n-pentyl, neopentyl, isopentyl, n-hexyl, 2-ethylbutyl, 1-methylpentyl, 1,3-dimethylbutyl, n-heptyl, 3-heptyl, 1-methylhexyl, isoheptyl, n-octyl, 2-ethylhexyl, 1,1,3,3-tetramethylbutyl, 1-methylheptyl, n-nonyl or 1,1,3-trimethylhexyl. R₁ and R₂ defined as C₃-C₉alkyl comprises unbranched and preferably branched groups, e.g. isopropyl, isobutyl, tert-butyl, neopentyl, isopentyl, 2-ethylbutyl, 1-methylpentyl, 1,3-dimethylbutyl, 3-heptyl, 1-methylhexyl, isoheptyl, 2-ethylhexyl, 1,1,3,3-tetramethylbutyl, 1-methylheptyl or 1,1,3-trimethylhexyl.

In a preferred embodiment of the invention one of R₁ and R₂ represents in a compound (I) hydrogen or C₁-C₉alkyl, particularly methyl or tert-butyl, and the other one represents C₃-C₉alkyl, particularly tert-butyl.

R₄ defined as C₁-C₃₀alkyl comprises unbranched and branched (where possible) groups, for example C₁-C₉alkyl with the above-mentioned meanings, or C₁₀-C₃₀alkyl, particularly straight chain C₁₉-C₃₀alkyl, e.g. n-decyl, n-dodecyl, n-tetradecyl, n-hexadecyl or n-octadecyl or higher homologues thereof.

R₄ defined as (C₁-C₄alkyl)₁₋₃-phenyl comprises phenyl that is substituted by 1 to 3 C₁-C₄alkyl groups, e.g. methyl or tert-butyl.

In the group (A) R₁′ and R₂′ have the same definitions as R₁ and R₂ defined above. In a preferred embodiment of the invention one of R₁′ and R₂′ represents in a group (A) hydrogen or C₁-C₉alkyl, particularly methyl, and the other one represents C₃-C₉alkyl, particularly tert-butyl. According to another preferred embodiment of the invention both R₁′ and R₂′ represent in a group (A) C₃-C₉alkyl, particularly tert-butyl.

In a compound (I) the index n represents a numeral from 1 through 60 and defines the number of repeating units derived from ethylene or propylene oxide or ethylene or propylene glycol. In a preferred embodiment of the invention, n represents numerals from 2 to 20, particularly numerals from 2 to 15.

A preferred embodiment of the invention relates to an aqueous functional fluid that comprises as component a) a 4-hydroxyphenylpropionic acid ester (I), wherein

one of R₁ and R₂ represents methyl; and the other one represents tert-butyl; or
both of R₁ and R₂ represent tert-butyl;
R₃ represents hydrogen or methyl;
R₄ represents hydrogen, C₁-C₉alkyl, or the group (A), wherein
one of R₁′ and R₂′ represents methyl; and the other one represents tert-butyl; or
both of R₁′ and R₂′ represent tert-butyl; and
n represents a numeral from 2 to 15.

A particularly preferred embodiment of the invention relates to an aqueous functional fluid that comprises as component a) a compound:

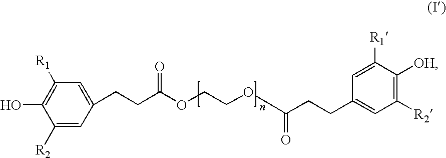

wherein
one of R₁ and R₂ represents methyl and the other one represents tert-butyl;
R₁′ and R₂′ are as defined as R₁ and R₂; and the index n represents a numeral from 2 to 15;
or R₁, R₁′, R₂ and R₂′ represent tert-butyl; and the index n represents a numeral from 2 to 15.

In a particularly preferred embodiment of the invention the aqueous functional fluid comprises as component a) a compound:

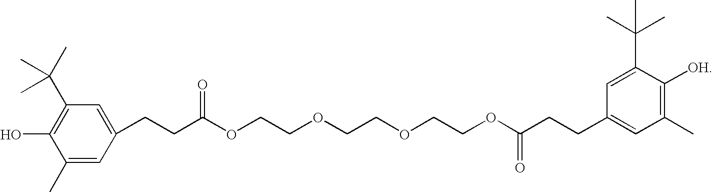

The compounds (I) are known and can be produced by known methods, such as the ones described in U.S. Pat. Nos. 4,032,562 and 5,696,281.

Component a) is present in the composition in an amount from 0.002 to 10.0%, preferably 0.002 to 5.0%, and most preferably 0.002 to 1.0%, based on the total weight of the composition.

Component a) is present in the concentrate described below in an amount from 0.01 to 10.0%, preferably 0.02 to 5.0%, and most preferably 0.01 to 2.0%, based on the total weight of the composition.

### Component b)

Polyalkylene glycol (polyalkylene oxides) or mixtures thereof are derived from polyethylene glycol or polypropylene glycol (=polyethylene oxide or polypropylene oxide) or mixed polymerisates thereof and are represented by the formula

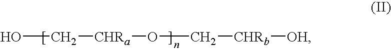

wherein n is a numeral from 1 to about 1.0×10⁶ and Rₐ and R_{b} represent hydrogen or methyl. Suitable water soluble polyalkylene glycol (polyalkylene oxides) or mixtures thereof are used as heat transfer fluids in the plastics industry and in the reflowing of printed circuit boards at temperatures of 200° C. to 240° C. They show improved performance over petroleum oils or non-aqueous solutions of polyethylene glycols because of their good thermal and oxidative stability, good heat transfer characteristics, high flash points, low tendency to sludge formation, non staining behaviour or low pour point.

Particularly preferred are high viscosity polyalkylene glycols that meet the following specifications:
Viscosity range according to ASTM D445 at 40° C. between 10 000 and 200 000 (cSt) and at 100° C. between 1 000 and 180 000;
Pour point according to ASTM D97 between 0° C. and 20° C.;
Flash point (open cup) above 200° C.;
Cloud point between 50-80° C.

Suitable water-soluble polyalkylene glycols are commercially available from ICI Corp. under the product name Emkarox® (Trademark ICI Corp.), particularly the specific products EMKAROX HV 19, 20, 26, 45, 105, 165.

Component b) is present in the composition in an amount from 0.5 to 95.0%, preferably 0.5 to 75.0%, and most preferably 0.1 to 50.0%, based on the total weight of the composition.

Component b) is present in the concentrate described below in an amount from 5.0 to 95.0%, preferably 10.0 to 90.0%, and most preferably 10.0 to 50.0%, based on the total weight of the composition.

### Component c)

The functional fluids contain about 60.0 to 99.0% water and about 40.0 to 1.0% concentrate. Preferably, the fluids contain about 75.0 to 99.0% water and about 25.0 to 1.0% concentrate. As a means of reducing corrosion, the pH of the fluid is maintained above 7. The fluids are easily formulated using tap water although distilled or deionised water is preferred.

### Component d)

The addition of at least one additional additive to the functional fluid is optional but preferred. Therefore, the invention also relates to an aqueous functional fluid comprising
a) A 4-hydroxyphenylpropionic acid ester (I′);
b) High viscosity, water soluble polyalkylene glycol or mixtures thereof;
c) Water; and, optionally,
d) Further additives suitable for aqueous hydraulic or metal working fluids.

The above-mentioned functional fluids, e.g. metal-working fluids or hydraulic fluids, may additionally comprise further additives that are added in order to improve their basic properties still further. Such additives include: further antioxidants, metal passivators, corrosion inhibitors, pour-point depressants, dispersants, detergents, further extreme-pressure additives and anti-wear additives. Such additives are added in the amounts customary for each of them, which range in each case approximately from 0.01 to 10.0%, preferably 0.1 to 1.0% by weight. Examples of further additives are given below:

### 1 Phenolic Antioxidants

### 1.1 Alkylated Monophenols

2,6-Di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear nonylphenols or nonylphenols branched in the side chain, such as 2,6-dinonyl-4-methylphenol, 2,4-dimethyl-6-(1′-methyl-undec-1′-yl)-phenol, 2,4-dimethyl-6-(1′-methylheptadec-1′-yl)phenol, 2,4-dimethyl-6-(1′-methyltridec-1′-yl)-phenol and mixtures thereof.

### 1.2 Alkylthiomethylphenols

2,4-Dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

### 1.3 Hydroquinones and Alkylated Hydroquinones

2,6-Di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tertbutyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

### 1.4 Tocopherols

α-, β-, γ- or δ-Tocopherol and mixtures thereof (vitamin E).

### 1.5 Hydroxylated Thiodiphenyl Ethers

2,2′-Thio-bis(6-tert-butyl-4-methylphenol), 2,2′-thio-bis(4-octylphenol), 4,4′-thio-bis(6-tert-butyl-3-methylphenol), 4,4′-thio-bis(6-tert-butyl-2-methylphenol), 4,4′-thio-bis(3,6-di-secamylphenol), 4,4′-bis(2,6-dimethyl-4-hydroxyphenyl)-disulphide.

### 1.6 Alkylidene Bisphenols

2,2′-Methylene-bis(6-tert-butyl-4-methylphenol), 2,2′-methylene-(6-tert-butyl-4-ethylphenol), 2,2′-methylene-bis[4-methyl-6-(a-methylcyclohexyl)phenol], 2,2′-methylene-bis(4-methyl-6-cyclohexylphenol), 2,2′-methylene-bis(6-nonyl-4-methylphenol), 2,2′-methylene-bis(4,6-di-tert-butylphenol), 2,2′-ethylidenebis(4,6-di-tert-butylphenol), 2,2″-ethylidene-bis(6-tert-butyl-4-isobutylphenol), 2,2′-methylene-bis[6-(α-methylbenzyl)-4-nonylphenol], 2,2′-methylene-bis[6-(α, α-dimethylbenzyl)-4-nonylphenol], 4,4′-methylenebis(2,6-di-tert-butylphenol), 4,4′-methylene-bis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]-terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane.

### 1.7 O-, N- and S-Benzyl Compounds

3,5,3′,5′-Tetra-tert-butyl-4,4′-dihydroxydibenzyl ether, octadecyl-4-hydroxy-3,5-dimethylbenzyl-mercaptoacetate, tridecyl-4-hydroxy-3,5-di-tert-butylbenzyl-mercaptoacetate, tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl) sulphide, isooctyl-3,5-di-tert-butyl-4-hydroxybenzyl-mercaptoacetate.

### 1.8 Hydroxybenzylated Malonates

Dioctadecyl-2,2-bis(3,5-di-tert-butyl-2-hydroxybenzyl) malonate, dioctadecyl-2-(3-tert-butyl-4-hydroxy-5-methylbenzyl) malonate, didodecylmercaptoethyl-2,2-bis(3,5-di-tert-butyl-4-hydroxybenzyl) malonate, di-[4-(1,1,3,3-tetramethylbutyl)-phenyl]-2,2-bis(3,5-di-tertbutyl-4-hydroxybenzyl) malonate.

### 1.9 Hydroxybenzyl Aromatic Compounds

1,3,5-tris(3,5-Di-tert-butyl-4-hydroxybenzyl)-2,4,6-trimethylbenzene, 1,4-bis(3,5-di-tertbutyl-4-hydroxybenzyl)-2,3,5,6-tetramethylbenzene, 2,4,6-tris(3,5-di-tert-butyl-4-hydroxybenzyl)phenol.

### 1.10 Triazine Compounds

2,4-bis-Octylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate.

### 1.11 Acylaminophenols

4-Hydroxylauric acid anilide, 4-hydroxystearic acid anilide, N-(3,5-di-tert-butyl-4-hydroxyphenyl)-carbamic acid octyl ester.

### 1.12 Esters of β-(5-tert-butyl-4-hydroxy-3-methylphenyl) propionic acid

With polyhydric alcohols, e.g. with 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, tris(hydroxyethyl)oxalic acid diamide, 3-thiaundecanol, 3-thiapentadecanol, trimethylhexanediol, trimethylolpropane, 4-hydroxymethyl-1-phospha-2,6,7-trioxabicyclo[2.2.2]octane.

### 1.13 Esters of β-(3,5-di-tert-butyl-4-hydroxyphenyl)propionic acid, O-(3,5-dicyclohexyl-4-hydroxyphenyl)propionic acid, 3,5-di-tert-butyl-4-hydroxyphenylacetic acid

With mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-hydroxyethyl oxalic acid diamide, 3-thiaundecanol, 3-thiapentadecanol, trimethylhexanediol, trimethylolpropane, 4-hydroxymethyl-1-phospha-2,6,7-trioxabicyclo[2.2.2]octane.

### 1.14 Amides of β-(3,5-di-tert-butyl-4-hydroxyphenyl)propionic acid

N,N′-bis(3,5-Di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

### 1.15 Ascorbic Acid (Vitamin C)

### 1.16 Aminic Antioxidants

N,N′-Diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′ dicyclohexyl-p-phenylenediamine, N,N′-diphenyl-p-phenylenediamine, N,N′-di-(naphth-2-yl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-tolueneonamido)-diphenylamine, N,N′-dimethyl-N,N′-di-sec-butylp-phenylenediamine, diphenylamine, N-allyldiphenylamine, 4-isopropoxydiphenylamine, 4-n-butylaminophenol, 4-butyrylaminophenol, 4-nonanoylaminophenol, 4-dodecanoylaminophenol, 4-octadecanoylaminophenol, di-(4-methoxyphenyl)amine, 2,6-di-tert-butyl-4-dimethylaminomethyl phenol, 2,4′-diaminodiphenylmethane, 4,4′-diaminodiphenylmethane, N,N,N′,N′-tetramethyl-4,4′-diaminodiphenylmethane, 1,2-di[(2-methylphenyl)amino]ethane, 1,2-diphenylaminopropane, o-tolylbiguanide, di-[4-(1,3′-dimethylbutyl)phenyl]amine, tert-octylated N-phenyl-1-naphthylamine, mixture of mono- and di-alkylated tert-butyl/tert-octyl-diphenylamines, mixture of mono- and di-alkylated nonyldiphenylamines, mixture of mono- and di-alkylated dodecyldiphenylamines, mixture of mono- and di-alkylated isopropyl/isohexyl-diphenylamines, mixtures of mono- and di-alkylated tert-butyldiphenylamines, 2,3-dihydro-3,3-dimethyl-4H-1,4-benzothiazine, phenothiazine, mixture of mono- and di-alkylated tert-butyl/tert-octyl-phenothiazines, mixtures of mono- and di-alkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl)sebacate, 2,2,6,6-tetramethylpiperidin-4-one, 2,2,6,6-tetramethylpiperidin-4-ol.

### 2. Further Antioxidants

Aliphatic or aromatic phosphites, esters of thiodipropionic acid or thiodiacetic acid or salts of dithiocarbamic acid, 2,2,12,12-tetramethyl-5,9-dihydroxy-3,7,11-trithiamidecane and 2,2,15,15-tetramethyl-5,12-dihydroxy-3,7,10,14-tetrathiahexadecane.

### 3 Metal Deactivators (e.g. for Copper)

### 3.1 Benzotriazoles and Derivatives Thereof

2-Mercaptobenzotriazole, 2,5-dimercaptobenzotriazole, 4- or 5-alkylbenzotriazoles (e.g. tolutriazole) and derivatives thereof, 4,5,6,7-tetrahydrobenzotriazole, 5,5′-methylene-bisbenzotriazole; Mannich bases of benzotriazole or tolutriazole, such as 1-[di-(2-ethylhexyl)aminomethyl]tolutriazole and 1-[di-(2-ethylhexyl)aminomethyl]benzotriazole; alkoxyalkylbenzotriazoles, such as 1-(nonyloxymethyl)benzotriazole, 1-(1-butoxyethyl)-benzotriazole and 1-(1-cyclohexyloxybutyl)-tolutriazole.

### 3.2 1,2,4-Triazoles and Derivatives Thereof

3-Alkyl- (or -aryl-) 1,2,4-triazoles, Mannich bases of 1,2,4-triazoles, such as 1-[di-(2-ethylhexyl)aminomethy1]-1,2,4-triazole; alkoxyalkyl-1,2,4-triazoles, such as 1-(1-butoxyethyl)-1,2,4-triazole; acylated 3-amino-1,2,4-triazoles.

### 3.3 Imidazole Derivatives

4,4′-Methylene-bis(2-undecyl-5-methyl) imidazole and bis[(N-methyl)imidazol-2-yl]-carbinol-octyl ether.

### 3.4 Sulphur-Containing Heterocyclic Compounds

2-Mercaptobenzothiazole, 2,5-dimercapto-1,3,4-thiadiazole, 2,5-dimercaptobenzothiadiazole and Derivatives Thereof; 3,5-bis[di-(2-ethylhexyl)aminomethyl]-1,3,4-thiadiazolin-2-one.

### 3.5 Amino Compounds

Salicylidene-propylenediamine, salicylaminoguanidine and salts thereof.

### 4. Corrosion Inhibitors

### 4.1 Organic Acids, their Esters, Metal Salts, Amine Salts and Anhydrides

Alkyl- and alkenyl-succinic acids and their partial esters with alcohols, diols or hydroxycarboxylic acids, partial amides of alkyl- and alkenyl-succinic acids, 4-nonylphenoxyacetic acid, alkoxy- and alkoxyethoxy-carboxylic acids, such as dodecyloxyacetic acid, dodecyloxy (ethoxy)acetic acid and amine salts thereof, and also N-oleoyl-sarcosine, sorbitan monooleate, lead naphthenate, alkenylsuccinic acid anhydrides, e.g. dodecenylsuccinic acid anhydride, 2-(2-carboxyethyl)-1-dodecyl-3-methylglycerol and salts thereof, especially sodium and potassium triethanolamine salts thereof.

### 4.2 Nitrogen-Containing Compounds

Tertiary aliphatic or cycloaliphatic amines and amine salts of organic and inorganic acids, e.g. oil-soluble alkyl ammonium carboxylates, and 1-[N,N-bis(2-hydroxyethyl)amino]-3-(4-nonylphenoxy)propan-2-ol; heterocyclic compounds: substituted imidazolines and oxazolines, e.g. 2-heptadecenyl-1-(2-hydroxyethyl)-imidazoline.

### 4.3 Sulphur Containing Compounds

Barium dinonylnaphthalene sulphonates, calcium petroleum sulphonates, alkylthio-substituted aliphatic carboxylic acids, esters of aliphatic 2-sulphocarboxylic acids and salts thereof.

### 5. Viscosity Index Enhancers

Polyacrylates, polymethacrylates, vinylpyrrolidone/methacrylate copolymers, polyvinylpyrrolidones, polybutenes, olefin copolymers, styrene/acrylate copolymers, polyethers.

### 6. Pour-Point Depressants

Poly (meth)acrylates, ethylene/vinyl acetate copolymers, alkyl polystyrenes, fumarate copolymers, alkylated naphthalene derivatives.

### 7. Dispersants/Surfactants

Polybutenylsuccinic acid amides or imides, polybutenyl phosphonic acid derivatives, basic magnesium, calcium and barium sulphonates and phenolates.

### 8. Extreme-Pressure and Anti-Wear Additives

Sulphur- and halogen-containing compounds, e.g. chlorinated paraffins, sulphurised olefins or vegetable oils (soybean oil, rape oil), alkyl- or aryl-di- or -tri-sulphides, benzotriazoles or derivatives thereof, such as bis(2-ethylhexyl)-aminomethyl tolutriazoles, dithiocarbamates, such as methylene-bis-dibutyldithiocarbamate, derivatives of 2-mercaptobenzothiazole, such as 1-[N,N-bis(2-ethylhexyl)aminomethyl]-2-mercapto-1H-1,3-benzothiazole, derivatives of 2,5-dimercapto-1,3,4-thiadiazole, such as 2,5-bis(tert-nonyldithio)-1,3,4-thiadiazole.

### 9. Coefficient of Friction Reducers

Lard oil, oleic acid, tallow, rape-oil, sulphurised fats, amides, and amines. Further exam ples are given in EP-A-0 565 487.

### 10. Special Additives for Use in Water/Oil Metalworking Fluids and Hydraulic Fluids

Emulsifiers, e.g. petroleum sulphonates, amines, such as polyoxyethylated fatty amines, non-ionic surface-active substances; buffers, e.g. alkanolamines; biocides, e.g. triazines, thiazolinones, tris-nitromethane, morpholine, sodium pyridenethiol; processing speed improvers, e.g. calcium and barium sulphonates.

The above-mentioned components may be admixed with the above-mentioned components a)-c) in a manner known per se according to prior art methods for preparing hydraulic or metal working fluids. It is also possible to prepare a concentrate or a so-called “additive package” that can be diluted to give the working concentrations for the intended lubricant. Therefore, the invention also relates to a concentrate comprising
a) A 4-hydroxyphenylpropionic acid ester (I), wherein R₁-R₄ and n are as defined above;
b) A high viscosity, water soluble polyalkylene glycol or mixtures thereof; and
c) The above-mentioned further additives suitable for aqueous hydraulic or metal working fluids.

The concentrates of the aqueous functional fluids can be made up free of water or contain any desired amount of water, but preferably contain up to 85% by weight of water to increase fluidity and provide ease of blending at the point of use. As pointed out above, these concentrates are diluted with water in the proportion of 1.0:99.0% to 40.0:60.0% to make up the final hydraulic or metal working fluid.

The aqueous functional fluids according to the present invention are transparent liquids being stable over long periods of storage and ambient temperature. In addition, the aqueous functional fluids are oil-free, do not support combustion, are ecologically clean and non-polluting as compared with existing functional fluids based on oil.

Another embodiment of the invention relates to a method for improving the performance properties of an aqueous functional fluid which comprises adding to an aqueous phase a 4-hydroxyphenylpropionic acid ester (I), wherein R₁-R₄ and n are as defined above.

The examples are intended for the purpose of illustration. Throughout the application, all parts, proportions and percentages are by weight and all temperatures are in degrees centigrade unless otherwise noted.

### EXAMPLES

### Stabilisation of Hydraulic and Metal Working Fluids with Selected 4-Hydroxyphenylpropionic Acid Esters

### a) Materials and Methods

Induction Temperature Measured Under PDSC Conditions

PDSC Test Conditions

| | |
|---|---|
| DSC cell | METTLER DSC27HP |
| Pan | Seiko Instrument Open Sample Pan |
| | diameter 5 mm, aluminium |
| Method | Dynamic method |
| Start temperature | 50° C. |
| Heating rate | 5° C./min |
| End temperature | 250° C. |
| Sample size | 2.7 +/− 0.1 mg |
| Gas | Oxygen 50 ml/min, 1 MPa (10 bar) |

Test Compounds

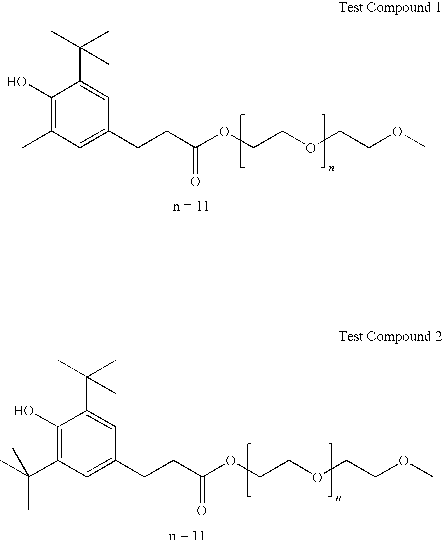

### b) Results

TABLE

| | | Demin. | Test | Test | | Induction |
|---|---|---|---|---|---|---|
| Example | EMKAROX | Water | Compound 1 | Compound 2 | | Temperature |
| No. | HV45 [%] | [%] | [%] | [%] | Aspect | [° C.] |
| 1 | 80.0 | 20.0 | — | — | — | 146.9 |
| 2 | 79.2 | 19.8 | 1.0 | — | — | 172.7 |
| 3 | 79.2 | 19.8 | — | 1.0 | Clear thick | 158.19 |
| | | | | | liquid | |
| 4 | 60.0 | 40.0 | — | — | — | 137.9 |
| 5 | 59.4 | 39.6 | 1.0 | — | — | 177.8 |
| 6 | 50.0 | 50.0 | — | — | — | 143.2 |
| 7 | 49.5 | 49.5 | 1.0 | — | — | 177.9 |
| 8 | 40.0 | 60.0 | — | — | — | 140.3 |
| 9 | 39.6 | 59.4 | 1.0 | — | — | 180.2 |
| 10 | 20.0 | 80.0 | — | — | — | 135.9 |
| 11 | 19.8 | 79.2 | 1.0 | — | — | 193.2 |
| 12 | 19.8 | 79.2 | — | 1.0 | Hazy | 165.01 |
| 13 | 19.8 | 80.0 | 0.2 | — | Completely | 182.14 |
| | | | | | clear | |

Overall concentration of Test Compound 1 = 0.2 weight %

1. An aqueous functional fluid comprising
a) 0.02 to 5.0 wt. % 4-hydroxyphenylpropionic acid ester 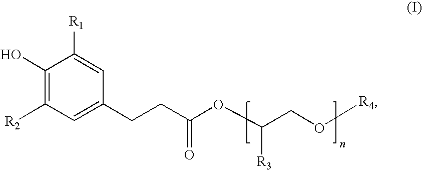
wherein
one of R₁ and R₂ represents hydrogen or C₁-C₉alkyl; and the other one represents C₃-C₉alkyl;
R₃ represents hydrogen or methyl;
R₄ represents hydrogen, C₁-C₃₀alkyl, (C₁-C₄alkyl)₁₋₃phenyl, phenyl or a group: 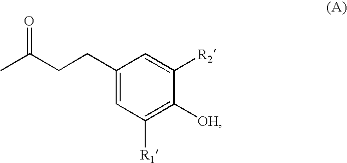
wherein
R₁′ and R₂′ have the same meanings as R₁ and R₂ defined above; and
n represents a numeral from 1 to 60;
b) 0.5. to 95 wt. % water soluble polyalkylene glycol or mixtures thereof having a viscosity range according to ASTM D445 at 40° C. between 10,000 and 200,000 (cSt) and at 100° C. between 1,000 and 180,000 (cSt), pour point according to ASTM D97 between 0° C. and 20° C., flash point (open cup) above 200° C. and cloud point between 50-80° C.; and
c) water, wherein the wt. % is based on the total weight of the composition.

2. The functional fluid according to claim 1 comprising as component a) a 4-hydroxyphenylpropionic acid ester (I), wherein
one of R₁ and R₂ represents methyl; and the other one represents tert-butyl; or
both of R₁ and R₂ represent tert-butyl;
R₃ represents hydrogen or methyl;
R₄ represents hydrogen, C₁-C₉alkyl, or the group (A), wherein
one of R₁′ and R₂′ represents methyl; and the other one represents tert-butyl; or
both of R₁′ and R₂′ represent tert-butyl; and
n represents a numeral from 2 to 15.

3. The functional fluid according to claim 2 comprising as component a) a 4-hydroxyphenyl propionic acid ester (I), wherein R₄ represents hydrogen or C₁-C₉ alkyl.

4. The functional fluid according to claim 3 comprising as component a) a 4-hydroxyphenyl propionic acid ester (I), wherein R₄ represents methyl.

5. The functional fluid according to claim 1 comprising as component a)
a 4-hydroxyphenylpropionic acid ester: 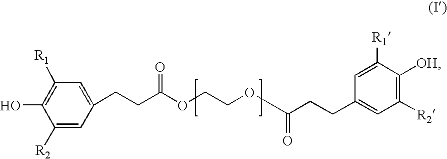
wherein
one of R₁ and R₂ represents methyl and the other one represents tert-butyl;
R₁′ and R₂′ are as defined as R₁ and R₂; and the index n represents a numeral from 2 to 15; or
R₁, R₁′, R₂ and R₂′ represent tert-butyl; or the index n represents a numeral from 2 to 15.

6. The functional fluid according to claim 1 comprising as component a) a compound:

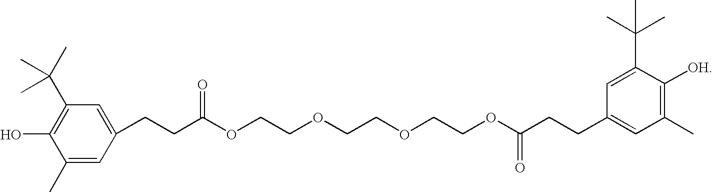

7. The functional fluid according to claim 1, wherein aqueous functional fluid means the functional fluid contains essentially no oil.

8. A method for improving the performance properties of a functional fluid which comprises adding to an aqueous phase c) about 40.0 to 1.0 wt. % concentrate comprising
a) a 4-hydroxyphenylpropionic acid ester (I): 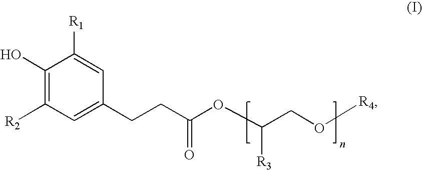
wherein
one of R₁ and R₂ represents hydrogen or C₁-C₉alkyl; and the other one represents C₃-C₉alkyl;
R₃ represents hydrogen or methyl;
R₄ represents hydrogen, C₁-C₃₀alkyl, (C₁-C₄alkyl)₁₋₃-phenyl, phenyl or a group: 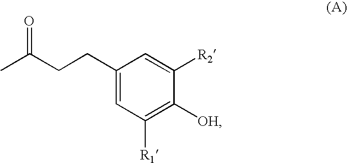
wherein
R₁′ and R₂′ have the same meanings as R₁ and R₂ defined above; and
n represents a numeral from 1 to 60;
b) a water soluble polyalkylene glycol or mixtures thereof having a viscosity range according to ASTM D445 at 40° C. between 10,000 and 200,000 (cSt) and at 100° C. between 1,000 and 180,000 (cSt), pour point according to ASTM D97 between 0° C. and 20° C., flash point (open cup) above 200° C. and cloud point between 50-80° C.; and
d) further additives suitable for aqueous hydraulic or metal working fluids.

9. The method according to claim 8 wherein
one of R₁ and R₂ represents methyl; and the other one represents tert-butyl; or
both of R₁ and R₂ represent tert-butyl;
R₃ represents hydrogen or methyl;
R₄ represents hydrogen, C₁-C₉alkyl, or the group (A), wherein
one of R₁′ and R₂′ represents methyl; and the other one represents tert-butyl; or
both of R₁′ and R₂′ represent tert-butyl; and
n represents a numeral from 2 to 15.

10. The method according to claim 9, wherein R₄ represents hydrogen or C₁-C₉ alkyl.

11. The method according to claim 10, wherein R₄ represents methyl.

12. The method according to claim 7 wherein component a)
is a 4-hydroxyphenylpropionic acid ester of formula (I′) 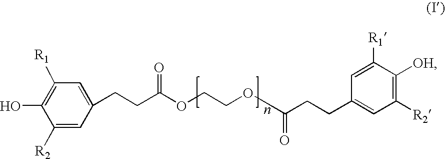
wherein
one of R₁ and R₂ represents methyl and the other one represents tert-butyl;
R₁′ and R₂′ are as defined as R₁ and R₂; and the index n represents a numeral from 2 to 15; or
R₁, R₁′, R₂ and R₂′ represent tert-butyl; or the index n represents a numeral from 2 to 15.

13. The method according to claim 7 wherein component a) is a compound: [chemical structure]
